(19) United States
(12) Patent Application Publication
(10) Pub. No.: US 2013/0141141 A1
(43) Pub. Date: Jun. 6, 2013

(54) DRIVER CIRCUIT FOR TRANSMITTING COIL OF ACTIVE ANTIMAGNETIC CARD COPYING DEVICE

(71) Applicants: Ismet Yesil, Yukari Dudullu (TR); Alp Devrim Kosal, Yukari Dudullu (TR)

(72) Inventors: Ismet Yesil, Yukari Dudullu (TR); Alp Devrim Kosal, Yukari Dudullu (TR)

(73) Assignees: Kronik Elektrik Ve Bilgisayar Sistemleri Sanayi Ticaret Limited Sirketi, Umraniye (TR); TMD HOLDING B.V., Blaricum (NL)

(21) Appl. No.: 13/698,695

(22) PCT Filed: May 18, 2011
(86) PCT No.: PCT/NL2011/050342

§ 371 Date: Dec. 6, 2012

(30) Foreign Application Priority Data
May 18, 2010 (TR) 2010/03922

(51) Int. Cl. G07F 19/00

(52) U.S. Cl. CPC G07F 19/201
USPC 327/110

(57) ABSTRACT

The present invention relates to a driver unit that locates the transmitter, which transmits magnetic field around the card insertion slot in order to prevent fraud in self-service terminals (SST) such as ATM, which enables transactions with magnetic tape cards.

### BACKGROUND OF THE INVENTION

The present patent application is a follow-up of international patent applications numbered PCT/TR2005/000007 and PCT/TR2009/000053 belonging to the owners of the same invention.

### TECHNICAL FIELD

The present invention relates to a driver unit driving a transmitter transmitting magnetic field around a card insertion slot in order to prevent fraud in self-service terminals (SST) such as ATM, which enables transactions with magnetic tape cards.

Magnetic cards are frequently used in banking transactions in particular and in ATMs, pumps at filling stations, buying of travel tickets or at self-service terminals (SST) that enable operations via personal accounts.

A self service terminal (SST) such as ATM, is divided into two group as motorized type and unmotorized type; the former takes the card in totally through a driver unit and the latter takes the card in partially. On the other hand, an ATM comprises a card insertion slot, a card driver unit, a card reader, a power unit and a processor as main structural components in motorized type devices.

In order to perform a transaction via ATM, firstly the user (card owner) inserts the magnetic card to the card insertion slot and in motorized type ATMs, the card is taken in through driver unit and in the meantime the data on the magnetic stripe of the card are read by the device. After the data are read, in case that the card belongs to a valid user, ATM sends instruction to the monitor for the user to enter the PIN code.

In SSTs such as ATM, in order to obtain the data on the magnetic card extorsively, another card reader (a fake card reader for fraud) is located before the card leading slot of the ATM, thus the magnetic card is firstly read by this fake card reader and then ATM's card reader reads the magnetic card, so the card information is copied without notice of the user (card owner).

In order to prevent the card information from being read with the intent of fraud by the card reader, there have been solution offers with the present invention owners among them. For example, according to a configuration mentioned in the applications PCT/TR2005/000007 and PCT/TR2009/000053, the copying device located by third parties, will be jammed by generating a magnetic field with a coil located around the insertion slot of SST's card reader, by means of which magnetic card information is aimed to be secured.

The criteria below should be met for the jammer device located to the insertion slot of SST card reader, to function in an effective way:

Signal Level: the jammer signal should suppress the signal level that the card generates while passing over the copier.

Signal Form: The signal generated should preferably be a non-filterable signal similar to that of the card data, and it should preferably not be self-recurrent, i.e. it should preferably not have a periodic form. The signal generated should preferably be on the random variable frequency between 500 Hz and 5 KHz, besides the form of the signal should preferably have an ever-changing form, i.e. the form should preferably vary as a function of time.

Fast control of the signal: In some circumstances that the signal should be disconnected according to certain conditions, resumption of the electromagnetic field in a fading manner due to some reasons such as anti-EMK of the coil may lead to an undesired result for the other devices not to be influenced. As a result, the signal is required to be controllable without any need to switch on and off the signal rapidly, i.e. without being subject to signal fading.

### BRIEF DESCRIPTION OF THE INVENTION

An object of the present invention is to effectively drive the coil transmitting magnetic field around the card insertion slot to prevent the copying of the card.

In order to achieve this object, the present invention relates to a driver circuit driving a transmitter coil that transmits a magnetic field to prevent a copying device from copying the card information, the copying device being located around a card insertion slot of an SST comprising a card insertion slot and a card reader.

In accordance with the present invention, the transmitter coil is driven by a control unit having an H-bridged or symmetric powered driver stage in order to control the direction of electromagnetic field and the signal form. A series capacitor is supplemented to the coil (transmitter) on H-bridge at the driver stage to increase performance by running the coil on series resonance.

### BRIEF DESCRIPTION OF THE FIGURES

FIG. 1 is a representative view of the card reader and a coil transmitting protective field, a detector to detect the foreign object and H-bridged driver stage.

FIG. 2 is a representative view of H-bridged driver stage.

FIG. 3 is a representative view of symmetric powered driver stage.

FIG. 4 is a symbolic view of the coil together with an ATM, the coil having a loop form and is led by the driver circuit according to the present invention.

### DETAILED DESCRIPTION OF THE INVENTION

If current flows over a coil, an electromagnetic field occurs on this coil. The direction of the electromagnetic field varies depending on the direction of the current, and the strength of the same varies depending on the current load.

Because data of the magnetic cards are stored after modulated with MFM (Modified Frequency Modulation) on magnetic stripe, both N and S poles are used in common magnetically in the card data. Thus, the electromagnetic field generated should influence both poles.

In order to achieve this, the transmitter coil is driven by an H-bridge (2) to generate an electromagnetic field having jamming effect on the coil used as transmitter (1). The direction of the current that flows over H-bridge and the coil can be changed. Depending on the direction of the current, the direction of the field generated is changed as well.

In addition to the inductance value (L) of the coil, an inductance reactance value (XL=2*Pi*L*F) is obtained according to the operating frequency (F) of the coil on alternate current. In order to increase the intensity of the field, the volume of the current that passes over the coil should be increased as well. Applied voltage level should be increased in order to raise the current value. By serially attaching a capacitor (3), which will reach to resonance on the working frequency, to the coil on the H-bridge (2), the inductive reactance value on the working frequency of the coil is decreased, and thus the excessive current flow for the same voltage level is ensured. Optionally, the coil (1) can be driven without capacitor (3), either with an H-bridged circuit or with a parallel capacitor.

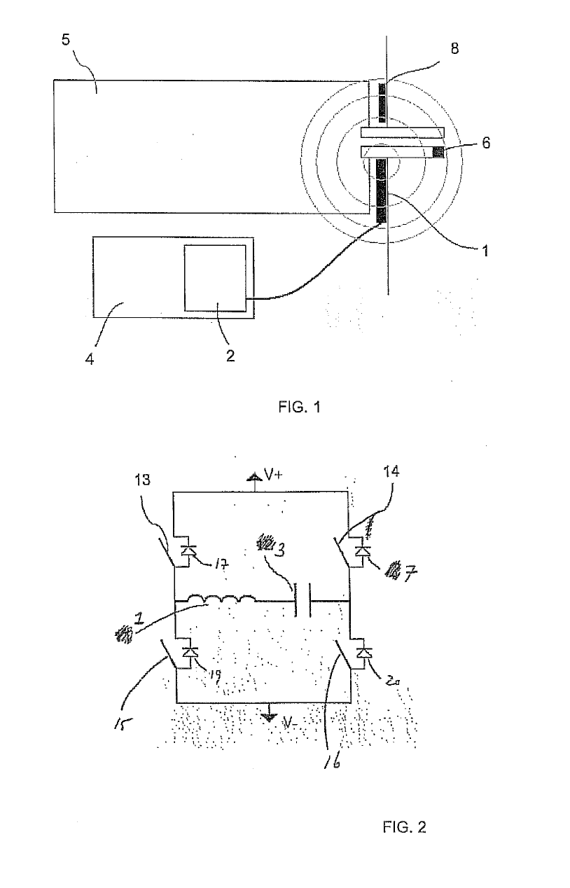

FIG. 2 shows a schematic diagram of a H-bridged driver stage. The stage includes a circuit. The circuit includes a sub-circuit comprising an inductor 1 and a capacitor 3 arranged in series for generating a resonance driving signal for driving the magnetic field sources of the anti-skimming unit. The circuit further includes two switch branches, each branch including a pair of switches 13, 15; 14, 16 arranged in series. The branches further include diodes, each diode 17, 19, 7, 20 being arranged in parallel with a corresponding switch 13, 15, 14, 16. The ends of the sub-circuit are connected to corresponding switch branches, between the switches, thus forming a H-bridge. The ends of the switch branches are connected to a high voltage terminal V+ and a low voltage terminal V−, respectively. By applying a H-bridge undesired fading effects are counteracted.

The control of the coil driven by an H-bridge (2) on the resonance and direction of the current of jamming signal form modulated with MFM is ensured by a control unit (4) comprising a suitable circuit/software, and the required current load necessary for the desired signal level is obtained effectively by running the coil on the resonance.

In motorized type card readers (5), the card reader takes the card in as mentioned below.

The card is placed to the insertion slot by the user, in the meantime a pre head (pre-reader) (6) situated before the insertion slot of the card-reader tries to read the data of magnetic stripe to control whether the card is put in the right direction or not. If the direction of the card is valid, the card is taken in for making the transaction. After the completion of the transaction, the card is given back to the user.

The jamming signal generated may influence the internal components of the card reader (5), such as “pre head” (6). Therefore, the jamming signal generated should be turned on/off in line with the working of the card reader or the signal level should be decreased.

The influence of the emf (electromotive force) generated by the transmitter coil on the H-bridge circuit is eliminated via flyback diodes (7) on the H-bridge circuit. All kinds of semi-conductor switching elements, such as transistor, mosfet, IGBT and non-semi conductor switching elements can be used with suitable connector as flyback diodes instead of diodes.

Because the control of current flow (thus, the generation of the magnetic field) over the coil during the current control is made by H-bridge, when the signal is needed to be stopped, rapid switching on or off of the current can be performed. When the current flow on the circuit is stopped by turning off the switching elements (13), the current is set to zero transiently; and because the influence of emf is eliminated by diodes, the current flow can be immediately stopped. Therefore, switching on and off the jamming field generated without obstructing the operation of the card reader is quickly ensured. The above mentioned switching elements (13) may comprise various kinds of semi-conductor or non-semi conductor switching elements, such as transistor, mosfet, IGBT.

Since the signal form and frequency in the magnetic field generated is provided by a control unit (4) comprising an H-bridged driver stage, the required signal form and frequency is obtained directly; flyback influence is eliminated by diodes (7), so the harmonics that emf (flyback) may cause, do not occur. Therefore, not only the other components on the card reader but also the systems such as detector used in anti-skimming solutions are less influenced.

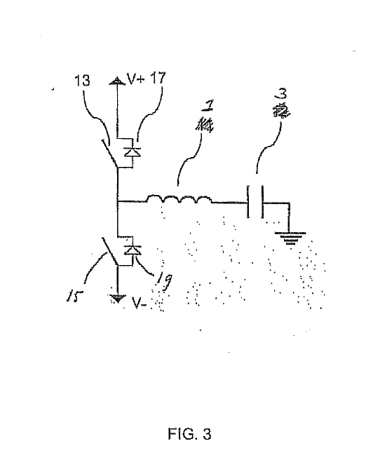

The driver circuit according to the present invention can be driven by a symmetric powered driver stage as shown in FIG. 3, instead of an H-bridged stage, as well. Similarly, the symmetric powered stage includes a circuit wherein a capacitor (3), which will reach to resonance on the working frequency, is serially attached to the coil (1) forming a sub-circuit. Further, the circuit includes a single switch branch having ends being connected to a high voltage terminal V+ and a low voltage terminal V−, respectively. The switch branch is similar to the switch branches of the driver circuit shown in FIG. 2, including a pair of switches 13, 15 arranged in series and diodes 17, 19 in parallel to the switches. A first end of the sub-circuit is connected to the switch branch, between the switches 13, 15. A second end of the sub-circuit is connected to ground. Bilateral control of the current is ensured by being switched with switching elements (13, 15) connected to the symmetric power source. The coil (1) is connected between two flyback diodes (7). Optionally, the coil (1) can be driven by a symmetric powered circuit without a capacitor (3) or with a parallel capacitor. In this circuit the flyback diodes (7) used in a similar way are various kinds of semi capacitor or non semi capacitor switching elements such as transistor, mosfet, IGBT.

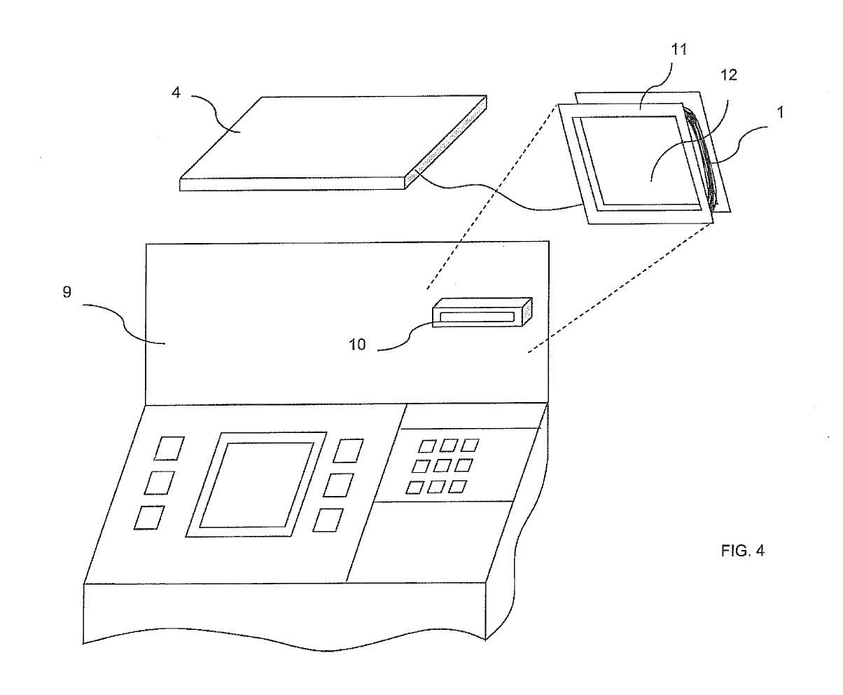

According to a preferred embodiment of the present invention, the transmitter coil (1) has a loop form as shown in FIG. 4 and it is located on the surface of SST (9) from inside or outside in such a way that it will surround the card insertion slot (10) of an SST (9), such as ATM. According to the preferred embodiment of the invention, the transmitter coil (1) can either have a quadrangle shape as a square or a rectangle or have regular and irregular loop form such as a triangle or a pentagon. The transmitter coil (1) is optionally wrapped to a magnetic or non-magnetic carrier (11). According to a preferred embodiment of the invention, the central part (12) of the loop transmitter (1) is hollow; in other words, the transmitter is an air-core type. The hollow central part (12) corresponds to the insertion slot (10).

1. A driver circuit driving a transmitter coil transmitting an electromagnetic field to prevent copying card information of a magnetic card by a copying device located around a card insertion slot of an SST comprising a card insertion slot and a card reader, wherein the driver circuit comprises an H-bridged driver circuit or a symmetric powered driver circuit.

2. A driver circuit according to the claim 1, wherein the H-bridge comprises flyback diodes for eliminating influence of emf that the transmitter coil generates.

3. A driver circuit according to the claim 1, further comprising a capacitor connected serially to the coil on the H-bridge.

4. A driver circuit according to the claim 1, wherein the H-bridge comprises semi-conductor or non-semi conductor switching elements such as transistor, mosfet, IGBT.

5. A driver circuit according to the claim 2, characterized in that flyback diodes used on the H-bridge comprise semi-conductor or non-semi conductor switching elements such as transistor, mosfet, IGBT.

6. A driver circuit driving a transmitter coil transmitting an electromagnetic field to prevent copying card information of a magnetic card by a copying device located around a card insertion slot of an SST comprising a card insertion slot and a card reader, wherein the driver circuit comprises a symmetric powered driver circuit.

7. A driver circuit according to the claim 6, wherein the symmetric powered driver circuit comprises flyback diodes for eliminating the influence of emf that the transmitter coil generates.

8. A driver circuit according to the claim 6, further comprising a capacitor connected serially to the coil.

9. A driver circuit according to the claim 6, wherein the symmetric powered driver circuit comprises semi-conductor or non-semi conductor switching elements, such as transistor, mosfet, and IGBT.

10. A driver circuit according to the claim 7, characterized in that flyback diodes used in the symmetric powered driver comprise semi-conductor or non-semi conductor switching elements, such as transistor, mosfet and IGBT.

11. A driver circuit according to claim 1, characterized in that the coil is run on serial or parallel resonance.

12. Driver circuit according to claim 1, characterized in that the transmitter coil comprises a loop form structure or having an air-core.

13. Driver circuit according to claim 12, characterized in that the loop form of the transmitter coil has a quadrangle shape such as square or rectangle, or has regular or irregular loop form such as triangle or pentagon.

14. A driver circuit according to claim 6, characterized in that the coil is run on serial or parallel resonance.

15. Driver circuit according to claim 6, characterized in that the transmitter coil comprises a loop form structure or having an air-core.

16. Driver circuit according to claim 15, characterized in that the loop form of the transmitter coil has a quadrangle shape such as square or rectangle, or has regular or irregular loop form such as triangle or pentagon.
